(19) United States
(12) Patent Application Publication
(10) Pub. No.: US 2004/0142188 A1
(43) Pub. Date: Jul. 22, 2004

(54) Colored film structure

(76) Inventor: Robert G. Peet, Pittsford, NY (US)

Correspondence Address: EXXONMOBIL CHEMICAL COMPANY, P O BOX 2149, BAYTOWN, TX, 77522-2149, US

(21) Appl. No.: 10/346,253

(22) Filed: Jan. 17, 2003

(51) Int. Cl. B32B 15/04

(52) U.S. Cl. 428/457; 428/461; 264/141

(57) ABSTRACT

An innovative coextruded, multi-layered, colored, polymeric film is provided. The film includes a thermoplastic core layer and a thermoplastic first layer containing a coloring agent. Matte layers containing a blend of two or more incompatible polyolefins and metal layers are independently provided depending on the desired application. Thermoplastic additional layers are optional. Further, the invention provides a method of manufacturing such films.

### BACKGROUND OF THE INVENTION

1. Field of the Invention

The present invention relates to colored thermoplastic film composites which are used for packaging materials and which provide an enhanced optical characteristic. In particular, these colored film composites impart excellent barrier properties (i.e., moisture and/or gas and/or light), yet provide an improved aesthetic look.

2. Description of Related Art

In the packaging industry, it is desirable to provide coextruded films made of thermoplastic materials, where at least one of the layers is colored so as to provide an identifying feature to the product contained therein, or to simply promote the product. It is common practice to employ a multi-layered film with certain types of foods, such as snack foods, e.g., potato chips, cookies and the like, where the films are not only utilized as a holding container, but also to prolong the shelf-life of the packaged material and promote same.

Throughout the years, a number of polymeric films have been developed to provide individual characteristics such as durability, strength, gas and/or moisture and/or light barrier properties, gloss or matte appearance, transparency or opacity, etc. In a large number of applications, these films undergo a conversion step in which the film is printed. The printing typically includes some moderate amount of information and a background design in which a distinctive or dramatic color is provided in the areas surrounding the product information. The design and color choice provide differentiation that increases the potential of discretionary choice among casual consumers. As described, color has heretofore typically been provided in a printing operation or other out-of-line operation.

A conventional system where a color film is manufactured by coating pigments onto a clear film is illustrated in U.S. Pat. No. 4,536,184 to Ryan. Therein, a process for printing onto the surface of a poly(vinyl chloride) resin substrate, virgin or dye-colored, is described. In particular, the '184 patent discloses overprinting a poly(vinyl chloride) resin substrate whose surface, or portion thereof, is colored by solvent soluble dye or by way of a mass solvent soluble dye, with a coloring agent made up of a liquid halogenated hydrocarbon solvent having 1-4 carbon atoms, pigment dispersed in the halohydrocarbon solvent, and a film-former, dissolved in the halohydrocarbon solvent, consisting essentially of (a) acrylic resin or (b) a combination of acrylic resin and chlorinated polyolefin, at least 50% by weight of acrylic resin; and heat treating the overprinted substrate to adhere the film-former and associated pigment.

U.S. Pat. No. 4,681,803 to Liu discloses a pigmented, heat-sealable coating composition for application to a primer-coated, oriented mono-layer or multilayer polyolefin film which comprises a blend of (a) a binding and oxygen barrier effective amount of a heat-sealable polyvinylidene chloride homopolymer and/or polyvinylidene chloride copolymer containing at least about 50 weight percent copolymerized vinylidene chloride, (b) an amount of wax sufficient to result in a significant reduction in the coefficient of friction of a film to which the coating composition is applied and (c) an amount of pigment sufficient to result in a significant reduction in the light transmission property of a film to which the coating composition is applied.

U.S. Pat. No. 5,492,757 to Schumann et al. discloses an opaque, matte, multilayer polypropylene film having at least one base layer and at least one interlayer, and an outer layer applied to the interlayer. The base layer includes polypropylene and fillers. The interlayer includes a mixture or blend of two components I and II, wherein component I is a propylene homopolymer or a copolymer of α-olefins having 2 to 10 carbon atoms, or a terpolymer of α-olefins having 2 to 10 carbon atoms, or a mixture or blend of these polymers and component II is a high density polyethylene (HDPE) or a blend of HDPE and a propylene homopolymer or copolymer of α-olefins having 2 to 10 carbon atoms, or a terpolymer of α-olefins having 2 to 10 carbon atoms, or a mixture or blend of these polymers. The outer layer essentially includes a copolymer of α-olefins having 2 to 10 carbon atoms, or a terpolymer of α-olefins having 2 to 10 carbon atoms, or a mixture or blend of these polymers.

U.S. Pat. No. 5,516,563 to Schumann et al. discloses an opaque, matte, multilayer polypropylene film including at least one base layer including polypropylene or a polypropylene mixture and fillers, and at least one outer layer which contains a mixture or blend of two components I and II.

Similarly, U.S. Pat. No. 5,618,369 to Peiffer et al. discloses a matte multilayer polypropylene film which includes at least one base layer containing polypropylene and migrating additives or a mixture of migrating additives, and at least one outer layer which includes a mixture or blend of two components I and II.

U.S. Pat. No. 5,683,805 to Oita et al. discloses a colored film formed of a transparent film and at least one colored adhesive layer arranged on one side of the transparent film. The adhesive layer has been colored by a colorant composed of a pigment and a dispersant. The dispersant comprises a (meth)acrylate ester polymer formed, as essential monomer components, of an aromatic vinyl monomer, a primary to tertiary amino-containing (meth)acrylate ester monomer and a (meth)acrylate ester monomer containing an ammonium group quaternized with an aromatic compound.

Among the disadvantages associated with the prior art films is the fact that they do not provide the requisite aesthetic appearance along with desired levels of barrier and/or mechanical properties and/or cost. The reliance of a film product on a separate out-of-line operation to provide a colorant to the film structure adds an unacceptable additional cost. Furthermore, adding a color through a printing step typically involves a large amount of ink to achieve color saturation, with a resultant significant pollution effect as the solvents are driven off in a drying step.

To meet the requirements of the packaging industry and to overcome the disadvantages of the related art, it is an object of this invention to provide a novel multi-layered film comprising a colorant in at least one of the coextruded layers and a matte layer providing a satiny appearance in at least one of the coextruded layers. Other than the matte layer, each layer of the multi-layered film, independently, may be clear or essentially clear or may comprise fillers and/or cavitators to create opacity.

It is a further object of the invention to provide a multi-layered film that comprises a colorant in at least one of the coextruded layers and a matte layer providing a satiny appearance in at least one of the coextruded layers, and that has a high barrier comprising a metallized layer. If fillers and/or cavitators to create opacity have not been used in the multi-layered film, the rich, satiny appearance of the matte layer maintains a subdued brilliance when seen from the side opposite the metallized layer.

It is yet another object of the invention to provide a multi-layered film that comprises a colorant in at least one of the coextruded layers and that has a high barrier comprising a metallized layer. Without fillers and/or cavitators to create opacity, the film maintains a rich brilliance when seen from the side opposite the metallized layer.

Other objects and aspects of the invention will become apparent to one of ordinary skill in the art on a review of the specification, drawing and claims appended hereto.

### SUMMARY OF THE INVENTION

In accordance with the present invention, an innovative coextruded multi-layered film is provided. The invention finds particular applicability in the packaging industry, where films are utilized to enclose a particular product and to identify and/or promote same.

According to a first aspect of the invention, a matte-appearing, multi-layered, colored, polymeric film is provided. The film comprises:

a thermoplastic core layer;

a thermoplastic first layer that comprises a coloring agent and is disposed on a first side of the thermoplastic core layer; and

a matte layer that comprises a blend of two or more incompatible polyolefins and is disposed on one of (i) a side of the thermoplastic first layer opposite the thermoplastic core layer and (ii) a second side of the core layer.

The multi-layered film, e.g., the thermoplastic core layer of the multi-layered film, may optionally comprise fillers and/or cavitators for opacity. Preferably, the matte layer is disposed on a side of the thermoplastic first layer opposite the thermoplastic core layer when the film, e.g., the thermoplastic core layer, comprises fillers and/or cavitators for opacity.

In accordance with a second aspect of the invention, a matte-appearing, multi-layered, colored, high barrier, polymeric film is provided. The film comprises:

a thermoplastic core layer;

a thermoplastic first layer that comprises a coloring agent and is disposed on a first side of the thermoplastic core layer;

a matte layer that comprises a blend of two or more incompatible polyolefins and is disposed on one of (i) a side of the thermoplastic first layer opposite the thermoplastic core layer and (ii) a second side of the core layer;

a thermoplastic second layer disposed on one of (i) a second side of the core layer when the matte layer is disposed on a side of the thermoplastic first layer opposite the thermoplastic core layer and (ii) a side of the thermoplastic first layer opposite the thermoplastic core layer when the matte layer is disposed on a second side of the core layer; and

a metal layer metallized on the thermoplastic second layer.

The multi-layered film, e.g., the thermoplastic core layer of the multi-layered film, may optionally comprise fillers and/or cavitators for opacity. Preferably, the matte layer is disposed on a side of the thermoplastic first layer opposite the thermoplastic core layer when the film, e.g., the thermoplastic core layer, comprises fillers and/or cavitators for opacity.

In accordance with a third aspect of the invention, a multi-layered, colored, high barrier, polymeric film is provided. The film comprises:

a thermoplastic core layer;

a thermoplastic first layer that comprises a coloring agent and is disposed on a first side of the thermoplastic core layer;

a thermoplastic second layer disposed on one of (i) a side of the thermoplastic first layer opposite the thermoplastic core layer and (ii) a second side of the core layer; and

a metal layer metallized on the thermoplastic second layer.

In accordance with yet another aspect of the invention, a method of manufacturing a multi-layered, colored, polymeric film is provided, comprising the steps of:

(a) forming an extrudable mass of a thermoplastic core layer;

(b) forming an extrudable mass of a thermoplastic first layer comprising a coloring agent therein;

(c) if a matte layer is to be present, forming an extrudable mass of a matte layer comprising a blend of two or more incompatible polyolefins;

(d) if a thermoplastic second layer is to be present, forming an extrudable mass of a thermoplastic second layer;

(e) coextruding the extrudable masses of steps (a), (b), (c), and (d), to form a cast web;

(f) stretching the cast web of step (e) in at least one direction to form a film; and

(g) if the film is to contain a metal layer, metallizing an outer surface of the thermoplastic second layer of the film.

### BRIEF DESCRIPTION OF THE DRAWINGS

The objects and advantages of the invention will become apparent from the following detailed description of the exemplary embodiments thereof in connection with the accompanying drawings, where like reference numerals denote same features, and in which:

FIG. 1 is a cross-sectional view of a multi-layered, colored, polymeric film that has a matte layer.

FIG. 2 is a cross-sectional view of the multi-layered, colored, polymeric film of FIG. 1, further containing a metal layer metallized on an outer surface of the film.

FIG. 3 is a cross-sectional view of a multi-layered, colored, polymeric film that has a metal layer metallized on an outer surface of the film.

### DETAILED DESCRIPTION OF THE INVENTION

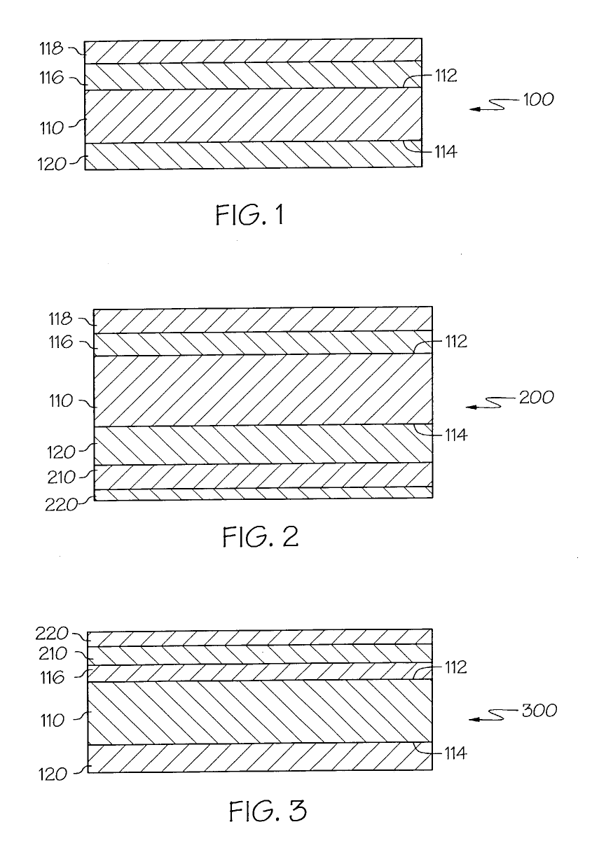

The invention will be described with reference to the accompanying FIGS. 1-3. It will be understood by those skilled in the art that these figures are intended to illustrate various aspects of the invention and are in no way limiting thereto.

FIG. 1 illustrates a multi-layered, colored, polymeric film comprising a matte layer, in accordance with a first aspect of the invention.

The multi-layered film 100 is provided with a thermoplastic core layer 110 that has a first surface 112 and a second surface 114. Core layer 110 may be manufactured from a thermoplastic material suitable for extrusion operations. For example, the thermoplastic material of core layer 110 may be a polyolefin.

A particularly desirable polyolefin that may be used as the film-forming material for core layer 110 is a polypropylene, such as an isotactic propylene homopolymer that has (i) an isotacticity of from about 80 to 99%, (ii) a melting point of from about 302° F. (150° C.) to about 329° F. (165° C.), and (iii) a melt flow rate of from about 0.5 to about 15 g/10 minutes (as measured according to ASTM D1238).

The polypropylene may be produced with Ziegler-Natta or single-site, e.g., metallocene, catalysts. Suitable Ziegler-Natta-catalyzed polypropylenes include, but are not limited to, PP 4612 from ExxonMobil Chemical Co. and PP 3371 from Fina Oil and Chemical Company. Metallocene-catalyzed polypropylenes made developmentally or commercially are EOD 96-21 and EOD 97-09, from Fina Oil and Chemical Co., EXPP-129 from ExxonMobil Chemical Co., and Novalen M from BASF GmbH, among others.

It will be understood by one of ordinary skill in the art that an isotactic polypropylene that has an isotacticity of from about 80 to 99% may be considered either a so-called standard, film-grade isotactic polypropylene or a highly crystalline polypropylene. Standard, film-grade isotactic polypropylene has an isotactic stereoregularity of from about 80% to about 95% or 96%. Highly crystalline polypropylene (HCPP) has an isotactic stereoregularity greater than about 95% or 96%. HCPP exhibits higher stiffness, surface hardness, lower deflection at higher temperatures and better creep properties than standard, film-grade isotactic polypropylene. Commercially available HCPPs include Amoco 9117 and Amoco 9119 (available from Amoco Chemical Co. of Chicago, Ill.), and Chisso 4141V (available from Chisso Chemical Co., Ltd. of Tokyo, Japan). Suitable HCPPs are also available commercially from Solvay in Europe.

For purposes of the present invention, stereoregularity can be determined by IR spectroscopy according to the procedure set out in “Integrated Infrared Band Intensity Measurement of Stereoregularity in Polypropylene,” J. L. Koenig and A. Van Roggen, Journal of Applied Polymer Science, Vol. 9, pp. 359-367 (1965) and in “Chemical Microstructure of Polymer Chains,” Jack L. Koenig, Wiley-Inerscience Publication, John Wiley and Sons, New York, Chichester, Brisbane, Toronto. Alternatively, stereoregularity can be determined by decahydronaphthalene (decalin) solubility or nuclear magnetic resonance spectroscopy (NMR), e.g., ¹³C NMR spectroscopy using meso pentads.

Other polyolefins that may be used as the film-forming thermoplastic material for core layer 110 include, but are not limited to, syndiotactic polypropylene, propylene-olefin copolymers, including ethylene-propylene copolymers, propylene-olefin terpolymers including ethylene-propylene-butene-1 terpolymers, and blends thereof.

Although if the thermoplastic material of core layer 110 is to be a polyolefin it is preferred for the polyolefin to comprise a propylene-containing polymer, in alternative embodiments, the polyolefin of core layer 110 may be an ethylene polymer, such as high density polyethylene (HDPE) or linear low density polyethylene (LLDPE).

HDPE has either no or moderate levels of long-chain branching and a density of, for example, from about 0.950 g/cm³ or higher, e.g., from about 0.952 g/cm³ to about 0.970 g/cm³, a melting point of, for example, from about 266° F. to about 299° F. (from about 130° C. to about 148° C.), and a melt index of from less than 1 to 50 g/10 min, e.g., from 1 to 10 g/10 min (as measured according to ASTM D1238).

LLDPE has either no or moderate levels of long-chain branching and typically has a melt index of from less than 1 to 50 g/10 min, e.g., from 1 to 10 g/10 min (as measured according to ASTM D1238) and a density in the range of from 0.910 to 0.940 g/cm³, preferably from 0.915 to 0.928 g/cm³.

HDPE and LLDPE may be produced via catalytic polymerization using a Ziegler-Natta catalyst or a metallocene or other single-site catalyst in a gas-phase, solution, or slurry process. They may be derived solely from ethylene or from ethylene together with other higher comonomers, such as butene-1, hexene-1 or octene-1.

Other polymers that may be used as the film-forming thermoplastic material for core layer 110 include, but are not limited to, polyamides, polyesters, polyvinyl chloride, polyvinylidene chloride, polystyrene, polycarbonate, polyethylene terephthalate, thermoplastic urethane, as well as co- and terpolymers of ethylene and ethylenically unsaturated carboxylic acids, such as methyl acrylate, butyl acrylate, ethyl acrylate, ethylene acrylic acid, ethylene methacrylic acid, combinations of these monomers, ionomers of the acid copolymers, ethylene-vinyl alcohol (EVOH), ethylene-vinyl acetate, maleic anhydride-grafted or modified polymer such as styrene maleic anhydride, polyethylene and polypropylene polymers modified with maleic anhydride, and the like. Blends of any of the foregoing homopolymers, copolymers and terpolymers are also contemplated.

If it is desired to produce an opaque multi-layered film, fillers and/or cavitators, i.e., cavitating agents, may be dispersed within the thermoplastic matrix of core layer 110. Suitable cavitating agents include any organic or inorganic material that is incompatible with (the term “incompatible” is used in the sense that the materials are two distinct phases), and has a higher melting point than, the film-forming thermoplastic material of core layer 110, at least at the orientation temperature.

Specific examples of the cavitating agent include titanium dioxide, silicon dioxide, silica, calcium carbonate, aluminum oxide, powdered aluminum, talc, iron oxide, carbon black, polybutylene terephthalate (PBT), polyamide, nylon, cyclic olefin copolymer, an acrylic resin, an ethylene-norborene copolymer, solid or hollow preformed glass spheres, metal beads or spheres, ceramic spheres, and combinations thereof. When core layer 110 comprising a cavitating agent is subjected to uniaxial or biaxial orientation, a cavity forms, providing a film having an opaque appearance.

Referring to FIG. 1, a thermoplastic first layer 116 is disposed on first surface 112 of core layer 110. Layer 116 may be any film-forming thermoplastic material that is capable of being coextruded, oriented and colored. Such materials include, but are not limited to, polyolefins, such as isotactic polypropylene, HDPE, low density polyethylene (LDPE), LLDPE, very low density polyethylene (VLDPE), ultra low density polyethylene (ULDPE), metallocene-catalyzed polyethylene and polypropylene, syndiotactic polypropylene, propylene copolymers and terpolymers which include other monomers such as ethylene and/or butene-1, ethylene copolymers and terpolymers which include other monomers such as propylene and/or butene-1.

LDPE is highly branched and typically has a density in the range of from 0.912 g/cm³ to 0.94 g/cm³, e.g., from 0.915 g/cm³ to 0.928 g/cm³, and a melt index of from less than 1 to 50 g/10 min, e.g., from 1 to 10 g/10 min (as measured according to ASTM D1238). LDPE may be produced in a high pressure process using free-radical initiators. LDPE polymerized at high pressure is sometimes referred to as high-pressure polyethylene.

VLDPE is a very low density polyethylene that has long-chain branching and typically has a density from about 0.88 g/cm³ to about 0.915 g/cm³, and a melt index of from less than 1 to 50 g/10 min, e.g., from 1 to 20 g/10 min (as measured according to ASTM D1238). ULDPE is an ultra low density polyethylene that typically has more long-chain branching than VLDPE, a density below 0.88 g/cm³, and a melt index of from less than 1 to 50 g/10 min, e.g., from 1 to 20 g/10 min (as measured according to ASTM D1238).

Typical copolymers are ethylene-propylene copolymers, ethylene-butene-1 copolymers, butene-1-propylene random copolymers, and ethylene-propylene block copolymers. Typical terpolymers are ethylene-propylene-butene-1 terpolymers.

Blends of any of the foregoing homopolymers, copolymers and terpolymers are contemplated.

Ethylene-propylene-butene-1 random terpolymers appropriate for use in the present invention include those containing 1-5% by weight random ethylene and 10-35% by weight random butene-1, with the balance being made up of propylene. The amounts of the random ethylene and butene-1 components in these terpolymers are typically in the range of 10 to 35% by weight (ethylene plus butene-1) based on the total amount of the copolymer. These copolymers and terpolymers typically have a melt flow rate in the range of about 1.5 to 15 g/10 min, with a density of about 0.9 and a melting point in the range of about 115 to about 170° C.

Other polymers that may be used as the film-forming thermoplastic material for first layer 116 include, but are not limited to, nylon, polyester, ethylene-vinyl acetate copolymer, and ethylene-vinyl alcohol copolymer.

Thermoplastic first layer 116 is colored to provide the multi-layered film with a homogeneous background color, e.g., red, green, blue. The coloring agent may be introduced into layer 116 in an amount up to about 90% by weight, preferably from about 2% to about 40% by weight, most preferably from about 3% to about 10% by weight of layer 116. U.S. Pat. Nos. 5,894,048; 4,894,264; 4,536,184; 5,683,805; 5,328,743; and 4,681,803 disclose the use of coloring agents, the disclosures of which are incorporated herein by reference in their entirety. Suitable coloring agents include pigments and dyes such as phthalocyanine, azo, condensed azo, azo lake, anthraquinone, perylene/perinone, indigo/thioindigo, isoindolinone, azomethineazo, dioxazine, quinacridone, aniline black, triphenylmethane and carbon black pigments; and inorganic pigments and dyes such as titanium oxide, iron oxide, iron hydroxide, chrome oxide, chromic acid, chrome vermilion, iron blue, aluminum powder and bronze powder pigments. These pigments may be provided in any form or may be subjected in advance to various dispersion treatments in a manner known per se in the art.

Depending on the material to be colored, the coloring agent can be added with one or more of various additives such as, film-forming resins, flame retardants, antioxidants, ultraviolet absorbers, plasticizers and surfactants. Colored compounded thermoplastics which are commercially available, frequently referred to as masterbatches, are easier to use with this invention, although direction addition of a dye or pigment to the extrusion is possible. Colored compounded thermoplastic concentrates may also be employed. For example, from Schulman: Polybatch Blue P4021, Polybatch Blue P4535, Polybatch Red P50346, Polybatch Yellow P2214F, Polybatch Green P3510F, Polybatch Brown P1028F, and Polybatch Orange P10307; from Ampacet: LR-92396 (blue), LR-92011 (blue), LR-92397 (green), LR-92398 (yellow), and LR-92010 (red); from Milliken Clear Tint Blue 9805, Clear Tint Red 9803, Clear Tint Amber 9808, and Clear Tint Green 9807, may be employed.

According to first and second embodiments of this invention, the multi-layered, colored, polymeric film comprises a matte layer. The matte layer has a matte appearance that serves to diffuse and somewhat mute the color displayed by first layer 116. The matte layer may be formed by providing a blend of two or more incompatible polyolefins. For example, the incompatible blend may be any one of those described in U.S. Pat. No. 6,322,894, the entire disclosure of which is incorporated herein by reference.

In particular, the matte layer may comprise a blend of: (i) a propylene homopolymer or propylene interpolymer; and (ii) an ethylene homopolymer or ethylene interpolymer. For purposes of the present invention, the term “interpolymer” includes various polymers other than homopolymers, such as random copolymers, terpolymers, etc., as well as block copolymers, graft copolymers, etc.

More particularly, the matte layer comprises a blend of (i) at least one of (1) a copolymer of ethylene and propylene or (2) a terpolymer of ethylene, propylene, and a C₄ to C₁₀ α-olefin and (3) a propylene homopolymer; and (ii) an ethylene polymer. Some examples of blends that may be used include, but are not limited to, a HDPE/ethylene-propylene-butylene (EPB) terpolymer blend, a polypropylene (PP)/HDPE blend, and a PP/polyethylene/EPB terpolymer blend.

Typically, the copolymer of ethylene and propylene (i)(1) and the terpolymer of ethylene, propylene and a C₄ to C₁₀ α-olefin (i)(2) is comprised predominantly of propylene. Such a copolymer or terpolymer typically contains more than about 60% propylene.

The ethylene polymer (ii) may include an ethylene copolymer or a blend of different kinds of ethylene polymers. For example, the ethylene polymer may be a blend of two or more ethylene polymers each having different densities. In one embodiment that is contemplated, the ethylene polymer comprises at least a first ethylene polymer that has a density of at least about 0.90 g/cm³ and a second ethylene polymer that has a density that is different from the density of the first ethylene polymer. For example, the blend may comprise high density polyethylene and low density polyethylene or linear low density polyethylene.

The ratio of the blend will vary depending upon the polyethylene components of the blend and the desired characteristics of the matte layer. In general, a blend in which an equal proportion of each component is employed, such as a 50:50 blend, may be useful. It has been found, however, that a blend containing 50% ethylene-propylene-butene-1 terpolymer, 40% high density polyethylene (0.95 g/cm³), and 10% of a lower density polyethylene (approx. 0.92 g/cm³) is particularly advantageous.

An important feature of the first and second embodiments of this invention is the positioning of the matte layer. The matte layer may be disposed on one of (i) a side of the thermoplastic first layer opposite the thermoplastic core layer and (ii) a second side of the core layer. In FIG. 1, the alternative wherein layer 118 is a matte layer represents alternative (i). In this alternative, layer 120 represents an optional thermoplastic additional layer. On the other hand, the alternative in FIG. 1 wherein layer 120 is a matte layer represents alternative (ii). In this alternative, layer 118 represents an optional thermoplastic additional layer. The thermoplastic additional layer, whether it be layer 118 or layer 120, is an optional layer, and the description provided herein does not exclude 3-layer films according to the first and second embodiments of this invention, wherein the only layers present are core layer 110, first layer 116, and matte layer 118 or 120.

Preferably, the matte layer is disposed on a side of the thermoplastic first layer opposite the thermoplastic core layer when the film, e.g., the thermoplastic core layer, comprises fillers and/or cavitators for opacity. In other words, alternative (i) is the preferred embodiment for opaque, multi-layered films according to the present invention.

Multi-layered, colored, polymeric films according to the present invention may optionally comprise one or more thermoplastic additional layers. In addition to the thermoplastic additional layer mentioned above (layer 120 in alternative (i) or layer 118 in alternative (ii)), a film may comprise one or more thermoplastic additional layers (a) between core layer 110 and first layer 116, (b) between first layer 116 and layer 118, (c) on a side of layer 118 opposite from first layer 116, (d) between core layer 110 and layer 120, and (e) on a side of layer 120 opposite from core layer 110. In each alternative (b) through (e), whether layer 118 is the matte layer and layer 120 is the additional layer, or vice-versa, is irrelevant to the addition of thermoplastic additional layers.

The thermoplastic additional layer(s) may be selected from any of the previously mentioned extrudable, film-forming thermoplastic materials, including, but not limited to, film-forming polyolefins such as a standard, film-grade isotactic polypropylene, a highly crystalline polypropylene, and HDPE.

In order to modify or enhance certain properties of the multi-layered, colored, polymeric films for specific end uses, it is possible for one or more of the layers to contain appropriate additives in effective amounts. The term “effective amount,” as used herein, is an amount sufficient to achieve the desired effect, e.g., an antiblocking effect for antiblock additives or an antistatic effect for antistatic additives. Examples of suitable additives may include, but are not limited to, waxes, antioxidants, antiozonants, antifogs, antistats, slip additives, antiblock additives, and combinations thereof.

The outermost surfaces of the outermost layers of the multi-layered, colored, polymeric film may be surface-treated. A surface-treated outer layer may be better able to retain ink or other further processing materials. In FIG. 1, the outermost layers are layers 118 and 120, but as mentioned, the outermost layers may alternatively be core layer 110 and matte layer 118 or first layer 116 and matte layer 120.

The surface treatment can be carried out by any method known in the art, including, but not limited to, corona discharge treatment, flame treatment, or plasma treatment. Although any of these techniques are effectively employed, a particularly desirable method of treatment is the so-called corona treatment method, which comprises exposing the film surface to a high voltage corona discharge while passing the film between a pair of spaced electrodes. The surface of the outer layer(s) may be treated to a surface tension level of at least about 35 dynes/cm, e.g. from about 38 to 55 dynes/cm, in accordance with ASTM Standard D2578-84.

A multi-layered, colored, polymeric film according to the present invention may have an image printed on one or both of the outermost surfaces of its outermost layers. Upon printing the outer layer(s), the film provides a satiny matte appearance as a colorful background. The printing inks and techniques useful in this process include, but are not limited to, flexogravure, rotogravure, litho, water- and solvent-based, as well as inkjet and hot-melts. Accordingly, the promotional advertising area is maximized.

The composition of the layers allows for a differential appearance of film 100 depending on the application. For clear or essentially clear films, i.e., non-opaque films that do not comprise any fillers and/or cavitators to create opacity, a first aspect may be viewed on matte layer 118 together with any printing or modifications thereto. A second aspect may be viewed on the opposite side of film 100, e.g., on additional layer 120, together with any printing or modifications thereto.

One metric for the differential appearance of the formed and/or packaged article can be defined in terms of light transmission through the film. The term “light transmission,” as used herein, will be understood to mean:

percent light transmission=T₂/T₁*100, where T₂ is the amount of light rays transmitted by a light source through a multi-layer film, e.g., film 100, while T₁ is the amount of light rays transmitted by the same light source with no intervening film.

As an example of a clear or essentially clear film according to the invention, layer 118 is a matte layer comprising a two-phase material, i.e., a blend of two incompatible polyolefins, and first layer 116, which is colored by a coloring agent, is disposed between matte layer 118 and core layer 110. Layer 120 is a thermoplastic additional layer. First layer 116 absorbs and/or scatters some of the incident light on the multi-layered film. Therefore, the percent light transmission through layers 116, 110, and 120 will be somewhat reduced in the range of 0-70%, preferably from 0-30%, and most preferably 0-5%.

This combination of reduced light transmission and internal scattering of light provides a more restrained or sedate look, typical of a paper-like or parchment-like look, or of a color-coated or printed film, when the film is viewed from the direction of matte layer 118. Moreover, it provides a desirable packaging material that protects the packaged product and simultaneously provides a muted colored background to the printed film.

Alternatively, the film may be viewed from the direction of thermoplastic additional layer 120. From this viewpoint, light transmission is relatively unimpeded until it reaches layer 1116, which may absorb and/or scatter some of the incident light, and layer 118, which absorbs and scatters more of the incident light. Upon observing an example film 100 from the direction of layer 120, film 100 has a somewhat modified muted colored background.

Those skilled in the art will recognize that the thickness of each layer is not particularly limited, and can vary over wide limits. Nevertheless, some preferred ranges are as follows. The matte layer (118 or 120) can have a thickness ranging from 0.5 to 10.0 microns. First layer 116 can have a thickness of about 0.5 to about 20 microns. Core layer 110 can have a thickness of about 5 to about 50 microns. Thermoplastic additional layers, whether layer 118, 120 or any other thermoplastic additional layer, can have a thickness ranging from 0 to 10 microns. Changes in these thicknesses will change the aesthetics of the films.

Films according to the present invention may be prepared using film technology that is well-known to those skilled in the art. For example, extrudable masses of the film-forming thermoplastic material (and any additional components or additives) for each individual layer are prepared. The extrudable masses may be cast-extruded, blown-extruded or coextruded, preferably coextruded, into a sheet using a flat die or tubular die. The sheet may then be oriented either uniaxially or biaxially by known stretching techniques.

Preferably, the films are biaxially oriented. For example, a multi-layered, colored, polymeric film according to the present invention may be biaxially oriented by stretching it from 3 to 7 times, e.g. from 4.5 to 5.5 times, in the machine direction (MD) and from 5 to 10 times, e.g., from 8 to 10 times, in the transverse direction (TD). The biaxial orientation may be performed sequentially, e.g., stretched in the MD followed by the TD, or it may be performed simultaneously, e.g., via the LISIM process.

With reference to FIG. 2, a cross-sectional view of multi-layered, colored, polymeric film 200 is presented. Film 200 is identical to film 100, with the exception that thermoplastic additional layer 210 and a metal layer 220 have been added. All the previous explanations, descriptions, compositions, and amplifications for the first embodiment and film 100 in FIG. 1 pertain to the second embodiment and film 200 in FIG. 2.

For example, as with film 100, the matte layer of film 200 may be disposed on one of (i) a side of the first layer 116 opposite core layer 110 and (ii) a second side of core layer 110. In FIG. 2, the alternative wherein layer 118 is a matte layer represents alternative (i). In this alternative, layer 120 represents an optional thermoplastic additional layer. On the other hand, the alternative in FIG. 2 wherein layer 120 is a matte layer represents alternative (ii). In this alternative, layer 118 represents an optional thermoplastic additional layer. Preferably, the matte layer is disposed on a side of the thermoplastic first layer opposite the thermoplastic core layer when the film, e.g., the thermoplastic core layer, comprises fillers and/or cavitators for opacity.

Whichever of layer 118 or layer 120 is the thermoplastic additional layer, it must be noted that thermoplastic additional layer 118 or 120 is an optional layer. The description provided herein does not exclude films according to the second embodiment of this invention, wherein the only layers present are core layer 110, first layer 116, additional layer 210, metal layer 220 and matte layer 118 or 120.

Also like film 100, multi-layered, colored, polymeric films according to this second embodiment of the invention may optionally comprise still further thermoplastic additional layers besides layers 210 and 118 or 120.

Thermoplastic additional layer 210 and metal layer 220 are depicted in FIG. 2 on a side of layer 120 opposite core layer 110. Alternatively, additional layer 210 and metal layer 220 may be disposed on a side of layer 118 opposite first layer 116. In short, either outermost surface of film 200 may be metallized.

With reference to FIG. 2, the preferred film structure according to the second embodiment of the invention is as follows: layer 118 is a matte layer comprising a blend of two or more incompatible polyolefins; layer 116 is a thermoplastic first layer comprising a coloring agent; layer 110 is a thermoplastic core layer; layer 120 is an optional thermoplastic additional layer; layer 210 is a thermoplastic additional layer; and layer 220 is a metal layer.

The metallization may be performed by vacuum deposition, or any other metallization technique, such as electroplating or sputtering. The metal may be aluminum, or any other metal capable of being vacuum deposited, electroplated, or sputtered, such as, for example, gold, zinc, copper, or silver.

Typically, metal layer 220 is applied to an optical density of from 1.5 to 5.0, e.g., from 1.8 to 2.6. Optical density is a measure of the absorption of visual light, and is determined by standard techniques. To calculate optical density, a commercial densitometer may be used, such as a Macbeth model TD 932, Tobias Densitometer model TDX or Macbeth model TD903. The densitometer is set to zero with no film specimen. A film specimen is placed over the aperture plate of the densitometer with the test surface facing upwards. The probe arm is pressed down and the resulting optical density value is recorded.

The thermoplastic material of additional layer 210, which provides the metallizable surface for the present multi-layered, colored, polymeric films, may be selected from the following non-exhaustive list of film-forming polymers: polypropylene, metallocene-catalyzed polypropylene, polyethylene, metallocene-catalyzed polyethylene, ethylene-propylene copolymers, ethylene-propylene, butene-1 terpolymers, propylene-butene-1 copolymers, LDPE, LLDPE, VLDPE, polyamides, polyesters, and blends of these materials. Preferably, the film-forming thermoplastic material of additional layer 210 is HDPE.

Depending on the selection of materials for the other layers of the film, e.g., layers 118, 116, 110, and 120, additional layer 210 may be rendered optional. For example, in a film structure containing matte layer 118, first layer 116, and core layer 110, the presence of optional thermoplastic additional layer 120 comprising, e.g., HDPE, may render layer 210 unnecessary, and layer 120 may be metallized. Or, if core layer 110 comprises, e.g., HDPE and optional layer 120 is not present, layer 210 may still be rendered unnecessary, and core layer 110 may be metallized.

Still further, the layer to be metallized may comprise a coloring agent. Thus, in a film comprising a first layer 116 containing a coloring agent, core layer 110, and matte layer 120, wherein optional layer 118 is not present, layer 210 may be rendered unnecessary, and first layer 116 may be metallized.

In preferred embodiments of the invention, however, the film is metallized on an outermost thermoplastic additional layer 210.

Metal layer 220 provides an excellent barrier to light, moisture, and gas, such as water vapor and oxygen.

Metal layer 220 also accentuates and homogenizes the appearance of the coloring agent found in layer 116. For example, consider a film 200 according to a preferred embodiment of the invention. Layer 118 is a matte layer, layer 116 a first thermoplastic layer comprising a coloring agent, layer 110 is a clear core layer that does not contain any fillers and/or cavitators, layer 120 is an optional thermoplastic additional layer, and layer 210 is a layer comprising, e.g, HDPE and metal layer 220 metallized thereon.

From a viewing perspective through matte layer 118, incident light travels through matte layer 118, colored layer 116, clear core 110, layer 120 (if present), layer 210, and is specularly reflected off metal layer 220 back through the same thermoplastic layers to the observer. The light-scattering and light-absorbance of layer 118 provides a muted but sparkling color, as witnessed by the observer.

In general, the amount of light transmitted completely through a film 200 will be low, regulated by the optical density of the metal layer applied in the metallization step. For example, the percent light transmission completely through a film 200 may be about 0-50%. This low light transmission completely through the multi-layered film provides a desirable packaging material that also protects the packaged product from deterioration caused by exposure to light.

As an added benefit, a composite film structure can be laminated to metal layer 220, thereby rendering metal layer 220 an interior layer of a multi-layered film.

Illustrated in FIG. 3 is a cross-sectional view of a multi-layered, colored, polymeric film 300 that has a metal layer metallized on an outer surface of the film. Film 300, which represents a third embodiment of the invention, does not include a matte layer.

All the previous explanations, descriptions, compositions, and amplifications for colored thermoplastic first layer 116, core layer 110, thermoplastic additional layer 210, and metal layer 220 pertain as well to this third embodiment of the invention. Because film 300 does not include a matte layer, layer 120 is simply an optional thermoplastic additional layer. Like previous films 100 and 200, film 300 may optionally comprise still further thermoplastic additional layers besides layer 120.

Thermoplastic additional layer 210 and metal layer 220 are depicted in film 300 of FIG. 3 on a side of first layer 116 opposite core layer 110. Alternatively, additional layer 210 and metal layer 220 may be disposed on a side of layer 120 opposite core layer 110, or on a side of core layer 110 opposite first layer 116, if layer 120 is not included. In short, either outermost surface of film 300 may be metallized.

In a preferred aspect of this third embodiment of the invention, film 300 includes a colored thermoplastic first layer 116 coextruded on first surface 112 of a clear core layer 10. Layer 120 is an optional thermoplastic additional layer that may be coextruded on surface 114 of core layer 110. Layer 210 is a metallizable, thermoplastic additional layer coextruded onto a side of first layer 116 opposite core layer 110. Metal layer 220 is metallized onto layer 210.

From a viewing perspective through optional layer 120 (or core layer 110 if layer 120 is not present), incident light travels through layer 120, core layer 110, colored thermoplastic first layer 116, where part of the light is absorbed by the coloring agent therein, and metallizable layer 210. Light is specularly reflected off metal layer 220 back through the same thermoplastic layers to the observer.

The percent internal light transmission of the combination of layer 120, core 110, colored layer 116, and metallizable layer 210 is quite high, from 50-99%, preferably from 70-99% and most preferably from 90-99%. This high internal light transmission allows the incident light to travel through layers 120, 110, 116, and 210 to metal layer 220 where it is reflected and transmitted back, providing film 300 with a deep, brilliant and vibrant color.

The amount of light transmitted completely through the structure will be low, regulated by the optical density of the metal layer applied in the metallization step. The percent light transmission completely through multi-layered film 300 is about 0-50%. This low light transmission completely through the multi-layered film provides a desirable packaging material that protects the packaged product from deterioration caused by exposure to light.

A multi-layered, colored, polymeric film according to this third embodiment of the invention may have an image printed on the outermost layer of the film opposite from the metal layer. For example, in film 300 depicted in FIG. 3, layer 120 may have an image printed thereon. The printed image may be used to display, e.g., the ingredients of the product contained within the multi-layered film package or to simply provide a promotional surface. Preferably, the outer layer is surface-treated prior to printing. It is contemplated that a further thermoplastic layer (not shown in FIG. 3) may be disposed on the printed layer to protect the integrity of the print. Colored layer 116 provides a background color for the printed image.

As mentioned with respect to metal layer 220 of film 200, it is contemplated that coating compositions or substrates such as another polymer film or laminate may be applied to metal layer 220 of film 300, thereby forming a sandwich-type laminate. When this type of sandwich laminate is formed, different colored layers can be disposed on opposite sides of metal layer 220, thereby providing a multi-layered film laminate that has the same or different background colors on its opposite sides.

It will be recognized by those skilled in the art that other substrates that can be applied to metal layer 220 include, for example, metal foils such as aluminum foil; cellulosic webs, e.g. numerous varieties of paper such as corrugated paperboard, craft paper, glassine, cartonboard; non-woven tissue, e.g., spunbonded polyolefin fiber, melt-blown microfibers, etc. The application may employ a suitable adhesive, e.g., a hot melt adhesive such as low density polyethylene, ethylene-methacrylate copolymer, water-based adhesive such as polyvinylidene chloride latex, and the like to bond the two halves of the laminate.

While the invention has been described in detail with reference to specific embodiments thereof, it will be apparent to one skilled in the art that various changes and modifications can be made, and equivalents employed, without departing from the scope of the appended claims.

What is claimed is:

1. A multi-layered, colored, polymeric film, comprising:
(a) a thermoplastic core layer;
(b) a thermoplastic first layer comprising a coloring agent on a first side of the core layer (a); and
(c) a matte layer comprising a blend of two or more incompatible polyolefins on one of (i) a side of first layer (b) opposite core layer (a) and (ii) a second side of core layer (a).

2. The film of claim 1, wherein core layer (a) comprises a cavitating agent and matte layer (c) is on (i) a side of first layer (b) opposite core layer (a).

3. The film of claim 1, wherein the blend of two or more incompatible polyolefins in matte layer (c) is selected from the group consisting of a high density polyethylene (HDPE)/ethylene-propylene-butylene (EPB) terpolymer blend, a polypropylene (PP)/HDPE blend, a PP/EPB terpolymer blend, an ethylene-propylene (EP) copolymer/polyethylene blend, and a PP/polyethylene/EPB terpolymer blend.

4. The film of claim 1, wherein matte layer (c) is on (i) a side of first layer (b) opposite core layer (a), and the film further comprises at least one thermoplastic additional layer on a second side of core layer (a).

5. The film of claim 4, further comprising a metal layer on an outer surface of the at least one thermoplastic additional layer that is an outermost layer of the film.

6. The film of claim 5, wherein the at least one thermoplastic additional layer that has a metal layer on an outer surface thereof comprises high density polyethylene.

7. The film of claim 1, wherein matte layer (c) is on (ii) a second side of core layer (a), and the film further comprises at least one thermoplastic additional layer on a side of first layer (b) opposite core layer (a).

8. The film of claim 7, further comprising a metal layer on an outer surface of the at least one thermoplastic additional layer that is an outermost layer of the film.

9. The film of claim 8, wherein the at least one thermoplastic additional layer that has a metal layer on an outer surface thereof comprises high density polyethylene.

10. A method of manufacturing the film of claim 1, comprising the steps of:
(1) forming extrudable masses of core layer (a), first layer (b), and matte layer (c);
(2) coextruding the masses of step (1) to form a sheet, wherein the layers (a), (b), and (c) have an order, from top to bottom, of (c)/(b)/(a) or an order, from top to bottom, of (b)/(a)/(c); and
(3) stretching the sheet of step (2) in at least one direction to form an oriented film.

11. A multi-layered, colored, polymeric film, comprising:
(a) a thermoplastic core layer;
(b) a thermoplastic first layer comprising a coloring agent on a first side of the core layer (a);
(c) at least one thermoplastic additional layer on one or more of (i) a side of first layer (b) opposite core layer (a) and (ii) a second side of core layer (a); and
(d) a metal layer on one outer surface of one thermoplastic additional layer (c) that is an outermost layer of the film.

12. The film of claim 11, wherein the one thermoplastic additional layer (c) that has a metal layer on an outer surface thereof comprises high density polyethylene.

13. The film of claim 11, wherein the at least one thermoplastic additional layer (c) is on a side of first layer (b) opposite core layer (a), and metal layer (d) is on the at least one thermoplastic additional layer (c).

14. The film of claim 11, wherein the at least one thermoplastic additional layer (c) is on a second side of core layer (a), and metal layer (d) is on the at least one thermoplastic additional layer (c).

15. The film of claim 11, wherein core layer (a) comprises a cavitating agent.

16. A method of manufacturing the film of claim 11, comprising the steps of:
(1) forming extrudable masses of core layer (a), first layer (b), and additional layer or layers (c);
(2) coextruding the masses of step (1) to form a sheet, wherein the layers (a), (b), and (c) have an order, from top to bottom, of (c)/(b)/(a);
(3) stretching the sheet of step (2) in at least one direction to form an oriented film; and
(4) depositing metal layer (d) on an outer surface of the at least one thermoplastic additional layer (c) that is an outermost layer of the film.
